(19) United States
(12) Patent Application Publication
(10) Pub. No.: US 2026/0233760 A1
(43) Pub. Date: Aug. 13, 2026

(54) SYSTEM AND METHOD FOR CALCULATING OBJECT HEADING BASED ON LIDAR AND DEEP LEARNING ALGORITHM

(71) Applicants: Hyundai Motor Company, Seoul (KR); Kia Corporation, Seoul (KR)

(72) Inventor: Woo Cheol CHOI, Hwaseong-Si (KR)

(21) Appl. No.: 19/365,967

(22) Filed: Oct. 22, 2025

(30) Foreign Application Priority Data
Feb. 12, 2025 (KR) 10-2025-0017981

(51) Int. Cl. B60W 60/00; B60W 50/00; G05B 13/02; G07C 5/04

(52) U.S. Cl. CPC B60W 60/00272; B60W 50/0097; G05B 13/027; G07C 5/04; B60W 2050/0022; B60W 2050/0028; B60W 2050/0054; B60W 2520/10; B60W 2554/20; B60W 2554/4044; B60W 2556/10

(57) ABSTRACT

An apparatus of a vehicle may comprise a processor and a memory storing at least one instruction that, when executed by the processor communicating with the memory, is configured to cause the apparatus to generate and store, based on data about a driving speed of the vehicle, driving history information in a queue of a specified size, determine a center point of a predicted bounding box for a target object recognized by a sensor and a deep learning model, generate and store first center history information comprising a center vector and second center history information comprising a relative map vector, determine a heading vector based on a weighted sum of the vectors, output a signal indicating the heading vector, and control, based on the signal, autonomous driving of the vehicle.

### CROSS-REFERENCE TO RELATED APPLICATION

This application claims the benefit of priority to Korean Patent Application No. 10-2025-0017981, filed in the Korean Intellectual Property Office on Feb. 12, 2025, the entire contents of which are incorporated herein by reference.

### TECHNICAL FIELD

The present disclosure relates to a system and a method for calculating an object heading based on a sensor (e.g., LiDAR) and deep learning algorithm, and more particularly, to a system for calculating an object heading based on artificial intelligence (AI) and deep learning, which is capable of accurately calculating the heading of a target object based on parameters such as a predicted bounding box (P-Box) and a center point extracted by deep learning, and a method thereof.

### BACKGROUND

The matters described in this Background section are only for enhancement of understanding of the background of the disclosure, and should not be taken as acknowledgment that they correspond to prior art already known to those skilled in the art.

As autonomous vehicles are developed and commercialized, the number of cases using various sensors and artificial intelligence (AI) technologies to support autonomous driving functions of vehicles has increased. For example, what objects exist in front of a moving vehicle, what the distance is between the object and the vehicle, and what algorithms the vehicle should use to respond to specific situations to ensure safety are being considered.

Accordingly, vehicle sensor technology has been more advanced, and high-performance sensors such as a light detection and ranging (LiDAR) that recognizes the surrounding environment using laser beams, a radio detection and ranging (radar) that uses radio waves, an ultrasonic sensor, a fisheye camera capable of photographing 360-degree images, a multifocal lens, and a global positioning systems (GPS), and the like have been installed in a vehicle.

By aggregating measurement results obtained from multiple sensors as described above, it may be possible to implement a super sensor vehicle. In autonomous driving (or self-driving), the concept of a super sensor refers to a technology that aims to recognize the surrounding environment more accurately by combining measurements from various sensors rather than relying on individual sensors for the convenience and safety of driving. With the addition of information and communications technology (ICT) and cloud technology, the sensors required for autonomous driving and the AI algorithms related to them may have become more sophisticated, not only targeting a single vehicle, but also remotely accumulating data from numerous vehicle units (fleet of vehicles) and training AI servers and databases to increase the reliability of vehicle sensor determination.

However, in the case of the LiDAR sensor, rather than creating a point cloud based on global coordinates, a sensor image may be created based on the movement of the vehicle, for example, arbitrary coordinates based on the location of the LiDAR sensor attached to the vehicle. In addition, because it may be difficult for the LiDAR sensor to obtain sufficient laser reflection point information for an object such as a vehicle at a distance due to its characteristics, the predicted bounding box (P-Box) of an object calculated by the AI algorithm for autonomous driving from the LiDAR sensor may have inaccurate heading (the direction in which the object moves) information, and errors such as the P-Box shaking or the P-Box flipping over may occur.

In autonomous driving, properly recognizing an external object using a sensor (e.g., LiDAR) and specifically when the object is a vehicle, accurately identifying the heading and heading direction of the vehicle, are directly related to driving safety.

Accordingly, a method of accurately extracting heading information when tracking an object using a LiDAR is considered.

### SUMMARY

The present disclosure has been made to solve the above-mentioned problems.

An example of the present disclosure provides a system and a method for calculating an object heading based on a LiDAR and deep learning, which are capable of accurately calculating the heading of a target object based on parameters such as a predicted bounding box (P-Box) and a center point extracted by deep learning.

The technical problems to be solved by the present disclosure are not limited to the aforementioned problems, and any other technical problems not mentioned herein will be clearly understood from the following description by those skilled in the art to which the present disclosure pertains.

In order to solve all or at least part of the technical problems described above, examples of the present disclosure may be implemented in various examples as follows.

According to the present disclosure, an apparatus of a vehicle, the apparatus may comprise a processor, and a memory storing at least one instruction that, when executed by the processor communicating with the memory, is configured to cause the apparatus to generate and store, based on data about a driving speed of the vehicle, driving history information, wherein the data is stored in a queue of a specified size in the memory, determine a center point of a predicted bounding box for a target object recognized by a sensor of the vehicle and a deep learning model while the vehicle is in a stationary state, generate and store first center history information may comprise a center vector, wherein the first center history information is generated and stored based on tracking the determined center point and the specified size of the queue, generate and store second center history information may comprise a relative map vector with respect to the vehicle, wherein the second center history information is generated and stored based on tracking the determined center point and a movement of the target object while the vehicle is in a moving state, based on a first weight for the first center history information and a second weight for the second center history information, determine a heading vector of the target object by obtaining a weighted sum of the center vector and the relative map vector, output a signal indicating the heading vector of the target object, and control, based on the signal, autonomous driving of the vehicle.

The apparatus, wherein the center vector is defined as follows vec_{center}=(posₜ−posₜ₋₁)+(velocity*dt) wherein vec_{center} represents the center vector, posₜ represents coordinates of the target object in a time t frame belonging to the specified size of the queue, posₜ₋₁ represents coordinates of the target object in a time t−1 frame belonging to the specified size of the queue, and velocity represents the driving speed of the vehicle.

The apparatus, wherein the relative map vector is defined as follows

$$v e {c}_{map} = \frac{{\sum }_{t = 0}^{n} p o {s}_{t + 1} - p o {s}_{t}}{n} + ( velocity * dt )$$

wherein vecₘₐₚ represents the relative map vector, posₜ₊₁ is coordinates of the target object in a time t+1 frame belonging to the specified size of the queue, and n is a time corresponding to the specified size of the queue.

The apparatus, Wherein the heading vector of the target object is defined as follows vec_{heading}=(w₁*vec_{center})+(w₂*vecₘₐₚ) wherein vec_{heading} represents the heading vector, w₁ represents the first weight, and w₂ represents the second weight.

The apparatus, wherein the first weight increases in value when the vehicle changes from the stationary state to the moving state, and the second weight increases in value when the vehicle turns while in the moving state.

The apparatus, wherein the at least one instruction, when executed by the processor communicating with the memory, is configured to cause the apparatus to execute reconstructing, based on the heading vector, an array of four plane corners of the predicted bounding box.

The apparatus, wherein the reconstructing of the array of four plane corners may comprise applying a Bayesian filter to the four plane corners.

The apparatus, wherein the reconstructing of the array of four plane corners may comprise applying a Bayesian filter to the heading vector.

The apparatus, wherein the at least one instruction, when executed by the processor communicating with the memory, is configured to cause the apparatus to execute calculating and updating, based on a magnitude and a direction of the heading vector, a total movement amount of a distance moved by the target object in the queue.

The apparatus, wherein the at least one instruction, when executed by the processor communicating with the memory, is configured to cause the apparatus to execute adjusting, based on whether the total movement amount being equal to zero or greater than a specified value, at least one of the first weight or the second weight.

According to the present disclosure, a method performed by an apparatus of a vehicle, the method may comprise generating and storing, based on data about a driving speed of the vehicle, driving history information, wherein the data is stored in a queue of a specified size in a memory of the vehicle, determining a center point of a predicted bounding box for a target object recognized by a sensor of the vehicle and a deep learning model while the vehicle is in a stationary state, generating and storing first center history information may comprise a center vector, wherein the first center history information is generated and stored based on tracking the determined center point and the specified size of the queue, generating and storing second center history information may comprise a relative map vector with respect to the vehicle, wherein the second center history information is generated and stored based on tracking the determined center point and a movement of the target object while the vehicle is in a moving state, based on a first weight for the first center history information and a second weight for the second center history information, determining a heading vector of the target object by obtaining a weighted sum of the center vector and the relative map vector, outputting a signal indicating the heading vector of the target object, and controlling, based on the signal, autonomous driving of the vehicle.

The method, wherein the center vector is defined as follows vec_{center}=(posₜ−posₜ₋₁)+(velocity*dt) wherein vec_{center} represents the center vector, posₜ represents coordinates of the target object in a time t frame belonging to the specified size of the queue, posₜ₋₁ represents coordinates of the target object in a time t−1 frame belonging to the specified size of the queue, and velocity represents the driving speed of the vehicle.

The method, wherein the relative map vector is defined as follows:

$$v e {c}_{map} = \frac{{\sum }_{t = 0}^{n} p o {s}_{t + 1} - p o {s}_{t}}{n} + ( velocity * dt )$$

wherein vecₘₐₚ represents the relative map vector, posₜ₊₁ is coordinates of the target object in a time t+1 frame belonging to the specified size of the queue, and n is a time corresponding to the specified size of the queue.

The method, wherein the heading vector of the target object is defined as follows: vec_{heading}=(w₁*vec_{center})+(w₂*vecₘₐₚ) wherein vec_{heading} represents the heading vector, w₁ represents the first weight, and w₂ represents the second weight.

The method, wherein the first weight increases in value when the vehicle changes from the stationary state to the moving state, and the second weight increases in value when the vehicle turns while in the moving state.

The method may further comprise Reconstructing, based on the heading vector, an array of four plane corners of the predicted bounding box.

The method, wherein the reconstructing of the array of four plane corners may comprise applying a Bayesian filter to the four plane corners.

According to the present disclosure, an apparatus of a vehicle, the apparatus may comprise a processor, and a memory storing at least one instruction that, when executed by the processor communicating with the memory, is configured to cause the apparatus to store a driving speed history of the vehicle and a center point history of a predicted bounding box associated with a target object, wherein the predicted bounding box is generated based on sensor data obtained from a sensor of the vehicle and a deep learning model, generate, based on tracking the center point history of the predicted bounding box while the vehicle is in a stationary state, a first center history may comprise a center vector, generate, based on tracking the center point history of the predicted bounding box while the vehicle is in a moving state, a second center history may comprise a map vector, determine a heading vector of the target object based on the center vector and the map vector, apply a filter to the heading vector, determine, based on a magnitude and a direction of the filtered heading vector, a total movement amount of the target object, and output, based on the filtered heading vector and the total movement amount of the target object, a signal indicating a heading of the target object and a trajectory of the target object.

The apparatus, wherein the at least one instruction, when executed by the processor communicating with the memory, is configured to cause the apparatus to determine the heading vector of the target object by determining a displacement between center point coordinates of the predicted bounding box in a current frame and a previous frame to obtain the center vector, and determining a relative displacement of the predicted bounding box with respect to a reference frame to obtain the map vector, wherein the reference frame corresponds to frame whose origin and orientation are defined relative to the vehicle and remain constant with respect to the vehicle.

The apparatus, wherein the at least one instruction, when executed by the processor communicating with the memory, is configured to cause the apparatus to apply corrections for inconsistencies in an arrangement of corner points of the predicted bounding box, and wherein the at least one instruction, when executed by the processor communicating with the memory, is configured to cause the apparatus to determine the heading vector by determining, based on a weighted sum of the center vector and the map vector, the heading vector, wherein a first weight is applied to the center vector and a second weight is applied to the map vector, and wherein at least one of the first weight and second weight is adjusted based on a movement state of the vehicle or a movement state of the target object, and apply the filter to the heading vector to reduce variations in heading estimation of the predicted bounding box.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of an overall system for automatically recognizing an object and controlling a vehicle for the purpose of autonomous driving or the like according to an example of the present disclosure;

FIG. 2 shows an example of an algorithm for calculating an object heading by using a LiDAR sensor of a vehicle and a deep learning-based AI algorithm according to an example of the present disclosure;

FIG. 3 shows an example of a process of generating first center history information about a center vector by tracking a center point of a P-Box according to an example of the present disclosure;

FIG. 4A and FIG. 4B show an example of a process of tracking the center point of a P-Box according to an example of the present disclosure when a vehicle equipped with a LiDAR (i.e., the host vehicle) stops;

FIG. 5A and FIG. 5B show an example of a process of generating second center history information regarding a map vector that relatively changes when tracking a center point of a P-Box according to an example of the present disclosure as a vehicle equipped with a LiDAR (i.e., a host vehicle) moves;

FIG. 6 shows an example of a process of synthesizing a center vector and a map vector according to an example of the present disclosure;

FIG. 7 show an example of the relationship between each vector according to Equation 1 to Equation 3 applied according to an example of the present disclosure;

FIG. 8 shows an example of a process of applying a Bayesian filter to a center vector and a map vector according to an example of the present disclosure;

FIG. 9 shows an example of a process of calculating the total movement amount of a target object according to an example of the present disclosure;

FIG. 10 shows a first example to which an example of the present disclosure is applied;

FIG. 11 shows a second example to which an example of the present disclosure is applied;

FIG. 12 shows a third example to which an example of the present disclosure is applied;

FIG. 13 shows a fourth example to which an example of the present disclosure is applied;

FIG. 14 shows a fifth example to which an example of the present disclosure is applied; and

FIG. 15 shows an example of a computing system for autonomous vehicle control and object recognition operations according to an example of the present disclosure.

### DETAILED DESCRIPTION

Hereinafter, some examples of the present disclosure will be described in detail with reference to the exemplary drawings. In adding the reference numerals to the components of each drawing, it should be noted that the identical or equivalent component is specified by the identical numeral even when they are displayed on other drawings. Further, in describing the example of the present disclosure, a detailed description of the related known configuration or function will be omitted when it is determined that it interferes with the understanding of the example of the present disclosure.

Terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure. For example, in the present disclosure, an object has virtually the same meaning as an object, and the expressions “object” and “object” are arbitrarily used interchangeably in the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICS, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of determining object heading based on a sensor and a learning model) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of determining object heading based on a sensor and a learning model) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of determining object heading based on a sensor and a learning model) described herein.

Minimum risk maneuver (MRM) operation(s) may also be controlled, for example, based on one or more features (e.g., features of determining object heading based on a sensor and a learning model) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of determining object heading based on a sensor and a learning model) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of determining object heading based on a sensor and a learning model) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., features of determining object heading based on a sensor and a learning model) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

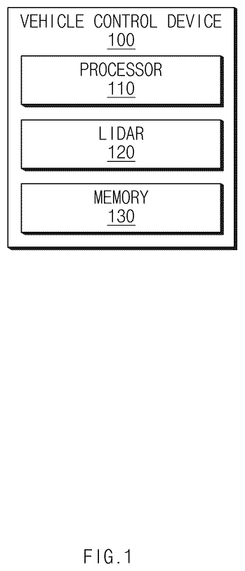

FIG. 1 shows an example of an overall system for automatically recognizing an object and controlling a vehicle for the purpose of autonomous driving or the like according to an example of the present disclosure.

Referring to FIG. 1, a vehicle control device 100 according to an example of the present disclosure may be implemented inside or outside a vehicle, and some of the components included in the vehicle control device 100 may be implemented inside or outside the vehicle. In this case, the vehicle control device 100 may be formed integrally with the internal control units of the vehicle, or may be implemented as a separate device and connected to the control units of the vehicle by a separate connection means. For example, the vehicle control device 100 may further include components (e.g., a power management module, a GPS receiver, a wireless communication interface, or an environmental sensor unit, etc.) not shown in FIG. 1.

The vehicle control device 100 according to an example may include a processor 110, a sensor (e.g., Light Detection And Ranging (LiDAR)) 120, and a memory 130. The processor 110, the LiDAR 120, or the memory 130 may be electronically and/or operably coupled with each other by an electronic component including a communication bus.

Hereinafter, hardware being operably coupled may mean that a direct connection or an indirect connection between the hardware is established via wired or wireless communication, such that a second hardware is controlled by a first hardware among the hardware.

Although shown in different blocks, the example is not limited thereto, and some of the hardware in FIG. 1 may be included in a single integrated circuit such as a system on chip (SoC). The type and/or number of hardware included in the vehicle control device 100 are not limited to that shown in FIG. 1. For example, the vehicle control device 100 may include only some of the hardware shown in FIG. 1, or may alternatively or additionally incorporate other processing circuitry (e.g., a neural processing circuit, a digital signal processor, a field-programmable gate array, or a GPU, etc.) depending on the computing requirements.

The vehicle control device 100 according to an example may include hardware for processing data based on one or more instructions. For example, the hardware for processing data may include the processor 110. For example, the hardware for processing data may include an arithmetic and logic unit (ALU), a floating point unit (FPU), a field programmable gate array (FPGA), a central processing unit (CPU), a graphic processing unit (GPU), and/or an application processor (AP). The processor 110 may have a single-core processor structure, or may have the structure of a multi-core processor including dual cores, quad cores, hexa cores, or octa cores, or other scalable configurations (e.g., deca cores, heterogeneous cores, or massively parallel architectures, etc.).

According to an example, the processor 110 may include at least one of a graphic processing unit (GPU), a neural processing unit (NPU), or any combination thereof. For example, a GPU may be referred to as a visual processing unit (VPU). For example, an NPU may be referred to as a neural network processing unit, or may be optimized for executing deep learning models such as convolutional neural networks, recurrent neural networks, or transformer-based models, etc.

The vehicle control device 100 according to an example may include a depth sensor for detecting an external object. For example, a depth sensor for detecting an external object may include at least one of a time-of-flight (ToF) sensor, the LiDAR 120, a structured light sensor, an ultrasonic sensor, an infrared sensor, a radio detection and ranging (radar), an optical distance sensor, a stereo camera sensor, or a photonic mixer device (PMD), etc., or any combination thereof. Hereinafter, for convenience of explanation, the description will focus on the LiDAR.

The vehicle control device 100 according to an example may include the LiDAR 120 that obtains a plurality of points forming a three-dimensional point cloud based on a pulse laser signal. Each point may represent a reflection from a surface of an external object, such as a vehicle, pedestrian, building, or roadway structure, etc. For example, the LiDAR 120 may obtain data sets that identify objects surrounding the vehicle control device 100 (or a vehicle including the vehicle control device 100). For example, the LiDAR 120 may identify at least one of the position, direction of movement, speed, or any combination thereof of surrounding objects based on the pulsed laser signal emitted from the LiDAR 120 being reflected back from surrounding objects, such as other vehicles, pedestrians, bicycles, road signs, or traffic cones, etc.

For example, the LiDAR 120 may obtain data sets representing external objects in the space formed by the x-axis, y-axis, and z-axis based on pulsed laser signals reflected from surrounding objects. The external objects may include, for example, vehicles, pedestrians, cyclists, lane boundaries, or infrastructure elements such as guardrails and traffic signs, etc. For example, the LiDAR 120 may obtain data sets including a plurality of points in the space formed by the x-axis, the y-axis, and the z-axis based on receiving a pulse laser signal at every specified time period. Each pulse may correspond to a laser scan cycle, enabling generation of a 3D point cloud frame that captures the surrounding environment. For example, the plurality of points may include points representing external objects within a three-dimensional virtual coordinate system. The 3D virtual coordinate system may include at least one of a vehicle coordinate system, a LiDAR coordinate system, or any combination thereof. However, examples of the 3D virtual coordinate system are not limited to those described above, and may additionally or alternatively include a global coordinate system, a map-based coordinate system, or an inertial reference frame, etc.

The memory 130 of the vehicle control device 100 according to an example may include a hardware component for storing data and/or instructions input and/or output to the processor 110. For example, the memory 130 may include a volatile memory including a random-access memory (RAM), and/or a non-volatile memory including a read-only memory (ROM), a persistent cache, or other computer-readable storage media, etc.

For example, the volatile memory may include at least one of a dynamic RAM (DRAM), a static RAM (SRAM), a cache RAM, a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disc, a solid state drive (SSD), an embedded multi-media card (eMMC), a universal flash storage (UFS), or a phase-change memory (PCM), etc., or any combination thereof.

In the memory 130 of the vehicle control device 100, one or more instructions (or commands) indicating calculation and/or operations to be performed by the processor 110 of the vehicle control device 100 with data may be stored. A set of one or more instructions may be referred to as a program, firmware, an operating system, a process, a routine, a sub-routine, and/or an application (e.g., a perception module, an object tracking module, or a motion planning routine, etc.).

Hereinafter, the fact that an application is installed in the vehicle control device 100 may mean that one or more instructions provided in the form of an application are stored in the memory 130, and that one or more applications are stored in a format executable by the processor 110 of the vehicle control device 100 (e.g., a file having an extension specified by an operating system of the vehicle control device 100) (e.g., a binary image, a compiled executable, or a containerized process with an extension recognized by the operating system of the vehicle control device 100, etc.).

For example, the memory 130 may include a first neural network model for detecting an object. For example, the memory 130 may include a second neural network model for outputting the types of the plurality of points obtained by the LiDAR 120 and/or the scores of the plurality of points (e.g., classification confidence scores, instance segmentation labels, or semantic labels, etc.).

In an example, the processor 110 may obtain at least one of a first virtual box representing a target object, a first class representing a type of the target object, or a combination thereof, based on the plurality of points obtained through the LiDAR 120 and the first neural network model stored in the memory 130.

For example, the processor 110 may obtain at least one of a first virtual box representing a target object, a first class representing a type of the target object, or any combination thereof, based on inputting the plurality of points into the first neural network model (e.g., a convolutional neural network, a point-based segmentation network, or a voxelized 3D object detection model, etc.). For example, the first neural network model may include an object detection model. For example, the target object may include an external object located within a specified distance from the vehicle control device 100 (or a host vehicle including the vehicle control device 100). For example, the target object may include an object that is identified by the vehicle control device 100 and is continuously tracked (e.g., a vehicle traveling in the adjacent lane, a pedestrian crossing at an intersection, or a cyclist moving along a bike lane, etc.). For example, the type of a target object may include multiple types for classifying the target object. For example, the type of the target object may include at least one of a first type representing the ground, a second type representing a type different from the ground (e.g., a vehicle, pedestrian, cyclist, or traffic cone, etc.), or any combination thereof. However, the type of a target object is not limited to the above. For example, the type of a target object may include, at least one of a third type representing a person, a fourth type representing a vehicle, a fifth type representing road barrier, a sixth type representing a static structure, or any combination thereof, etc.

In an example, the processor 110 may obtain, based on the plurality of points and the second neural network model, at least one of first partial points corresponding to at least a part of the target object among the plurality of points, a second class identified through the first partial points and indicating the type of the target object, or any combination thereof. For example, the second neural network model may include a segmentation model (e.g., a PointNet-based classifier, a sparse convolutional network, or a U-Net-like architecture, etc.).

For example, the second neural network model may include a neural network model for obtaining types of the plurality of points and associated scores of the plurality of points (e.g., per-point classification confidence, region-based objectness scores, or softmax probability values, etc.).

For example, the processor 110 may obtain first partial points corresponding to at least a portion of the target object among the plurality of points based on inputting the plurality of points into the second neural network model. For example, the processor 110 may identify the types of the plurality of points (e.g., classifying them as belonging to a car, pedestrian, bicycle, road surface, or vegetation, etc.) based on the second neural network model's output (e.g., output obtained by inputting the plurality of points into the second neural network model). For example, the processor 110 may obtain the first partial points corresponding to at least a portion of the target object from among the plurality of points based on the type of each of the plurality of points (e.g., points classified as belonging to a vehicle, person, or roadside structure, etc.).

In an example, the processor 110 may perform a first specified algorithm for a plurality of points. For example, the processor 110 may perform the first specified algorithm for classifying a type of each of the plurality of points for a plurality of points (e.g., distinguishing ground, road, object, or background points, etc.). For example, the processor 110 may classify second partial points corresponding to a specified type among the plurality of points. For example, the specified type may include a type representing the ground (e.g., pavement, curb, or sloped shoulder, etc.).

For example, the processor 110 may classify the second partial points corresponding to a specified type based on performing the first specified algorithm on the plurality of points, and obtain (or identify) the first partial points by excluding the second partial points from among the plurality of points, for example, to isolate the points corresponding to one or more target objects.

In an example, the processor 110 may obtain at least one of a partial class for obtaining a second class, a score of each of the plurality of points, or any combination thereof, based on inputting the plurality of points into the second neural network model (e.g., to determine per-point semantic categories, confidence values for object association, or classification likelihoods for instance segmentation, etc.). For example, the processor 110 may obtain a partial class and a score for each of the plurality of points based on inputting the plurality of points into the second neural network model. For example, the partial class may include a classification of each of the plurality of points into an arbitrary type (e.g., vehicle, pedestrian, cyclist, terrain, or vegetation, etc.).

For example, the processor 110 may fuse the partial class, the score of each of the plurality of points, and the second partial points (e.g., by combining semantic labels, confidence scores, and spatial proximity metrics, etc.). For example, the processor 110 may perform clustering based on the fusion of the partial class, the score of each of the plurality of points, and the second partial points. For example, clustering may include grouping the first partial points that correspond to at least part of a target object (e.g., to separate nearby objects such as adjacent vehicles or pedestrians standing together, etc.).

For example, the processor 110 may obtain a point cloud for generating a second virtual box based on the first partial points. For example, the processor 110 may obtain the point cloud based on grouping the first partial points, for example, into a unified object representation in three-dimensional space.

For example, the processor 110 may generate a second virtual box for representing the target object, which is different from the first virtual box, based on the point cloud. For example, the second virtual box may include a box that includes at least some of the first partial points (e.g., a refined bounding box fitted to the clustered points representing a vehicle or pedestrian, etc.).

For example, the processor 110 may identify a heading direction indicating the moving direction of the target object based on at least one of the first partial points, the point cloud, or any combination thereof.

For example, the processor 110 may identify the position of the second virtual box in a virtual coordinate system based on at least one of the first partial points, the point cloud, or any combination thereof (e.g., by calculating a vector between sequential center points or analyzing shape orientation, etc.). For example, the processor 110 may identify the size of the second virtual box based on at least one of the first partial points, the point cloud, or any combination thereof. For example, the processor 110 may identify the second class based on at least one of the first partial points, the point cloud, or any combination thereof (e.g., classifying the object as a car, truck, cyclist, pedestrian, or traffic barrel, etc.). For example, the processor 110 may identify at least one of the heading direction indicating the moving direction of a target object, the position of the second virtual box in the virtual coordinate system, the size of the second virtual box, the second class, or any combination thereof, based on at least one of the first partial points, the point cloud, the spatial distribution of the clustered points, or any combination thereof (e.g., to support downstream modules such as path planning or collision avoidance, etc.). For example, the processor 110 may identify the heading direction of the bounding box based on at least one of the first virtual box, the first class, the heading direction of the second virtual box, the position of the second virtual box, the size of the second virtual box, the second class, or any combination thereof (e.g., by estimating orientation using geometric alignment or motion cues derived from previous frames, etc.). For example, the processor 110 may identify the position of the bounding box in the virtual coordinate system based on at least one of the first virtual box, the first class, the heading direction of the second virtual box, the position of the second virtual box, the size of the second virtual box, the second class, or any combination thereof (e.g., to register object location relative to the vehicle coordinate system or map frame, etc.). For example, the processor 110 may obtain a third class indicating the type of a target object corresponding to the bounding box based on at least one of the first virtual box, the first class, the heading direction of the second virtual box, the position of the second virtual box, the size of the second virtual box, the second class, or any combination thereof (e.g., to refine object classification using multi-stage inference that incorporates geometric and contextual features, etc.). For example, the processor 110 may obtain at least one of the heading direction of the bounding box, the position of the bounding box in the virtual coordinate system, the third class indicating the type of a target object corresponding to the bounding box, or any combination thereof, based on at least one of the first virtual box, the first class, the heading direction of the second virtual box, the position of the second virtual box, the size of the second virtual box, the second class, or any combination thereof (e.g., to enable real-time object tracking and behavioral prediction in an autonomous driving context).

For example, the processor 110 may assign a first identifier for tracking the second virtual box to the second virtual box (e.g., an object ID such as ID_23 or Track_7, etc.). For example, the processor 110 may assign a second identifier corresponding to the first identifier to the bounding box (e.g., for maintaining temporal consistency across frames, etc.).

For example, the processor 110 may track the bounding box by using the second identifier. For example, the processor 110 may track a target object based on identifying a plurality of bounding boxes including the bounding box to which the second identifier is assigned, in a plurality of frames (e.g., from time t to t+N, etc.). For example, because the second identifier is an identifier assigned to the bounding box corresponding to the target object, the processor 110 may track the target object by identifying the plurality of bounding boxes to which the second identifier is assigned, in the plurality of frames (e.g., using a Kalman filter, Hungarian algorithm, or feature association network, etc.).

In an example, the processor 110 may output the bounding box corresponding to the target object based on at least one of the first virtual box, the first class, the first partial points, the second class, or any combination thereof. For example, the bounding box may include an example of a target object represented in the virtual coordinate system in the form of a hexahedron (e.g., a 3D box aligned to the object's orientation with defined width, height, and length, etc.).

Hereinafter, operations performed by a CPU, a GPU, and/or an NPU included in the processor 110 will be briefly described (e.g., neural inference, clustering, or point classification tasks, etc.).

In an example, the processor 110 may include at least one of a CPU, a GPU, an NPU, or any combination thereof. For example, at least one of the GPU, the NPU, or any combination thereof may obtain the first virtual box and the first class based on the first neural network model. For example, at least one of the GPU and the NPU may obtain the first virtual box and the first class (e.g., a YOLO-style 3D detector or a voxel-based model, etc.). For example, at least one of the GPU, the NPU, or any combination thereof may obtain the partial class for obtaining the second class and the score for each of the plurality of points based on the second neural network model (e.g., a segmentation model like PointNet++ or KPConv, etc.). For example, at least one of the GPU and the NPU may obtain the partial class for obtaining the second class and the score for each of the plurality of points based on the second neural network model (e.g., assigning “vehicle” to a subset of points with a confidence score of 0.92, etc.). For example, the CPU may classify second partial points among the plurality of points that correspond to a specified type, based on performing the first specified algorithm for classifying the type of each of the plurality of points for the plurality of points (e.g., ground removal using height thresholding or planar segmentation, etc.).

As described above, the vehicle control device 100 according to an example may include at least one processor 110. The vehicle control device 100 may accurately detect a target object by detecting the target object using at least one processor 110 (e.g., a pedestrian crossing the road, a vehicle merging into a lane, or a cyclist, etc.). In addition, by performing parallel processes, the vehicle control device 100 may reduce the load on each processor (e.g., distributing neural inference and clustering across CPU, GPU, and NPU, etc.).

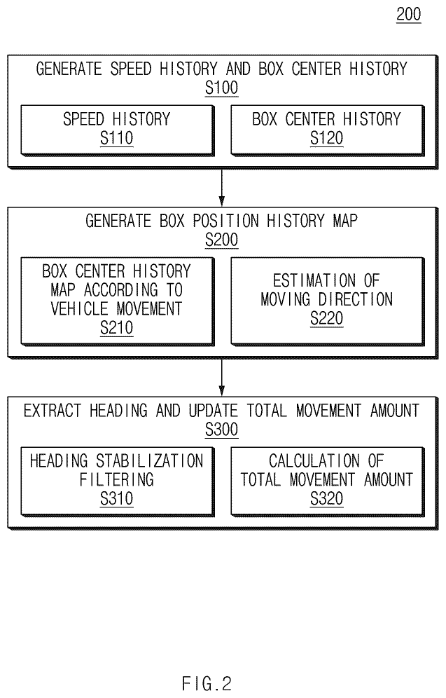

FIG. 2 shows an example of an algorithm 200 for calculating an object heading by using the LiDAR sensor 120 of the vehicle and a deep learning-based AI algorithm according to an example of the present disclosure. For reference, the object heading calculation algorithm 200 by AI according to an example of the present disclosure accesses the processor 110 and the memory 130 of FIG. 1 to perform various AI operations, and the basic data input to the algorithm 200 is input from the LiDAR 120 (e.g., 3D point cloud data sampled at 10 Hz, etc.).

In operation S100, the speed of a vehicle (i.e., a host vehicle) equipped with the LiDAR 120 is measured and its history is stored, while the history information of tracking the center point (or center) of a predicted bounding box (P-Box) inferred by deep learning from an image recognized by the LiDAR 120 is generated and stored as first center history information (e.g., storing [x, y] coordinates of bounding box centers across multiple time frames, etc.).

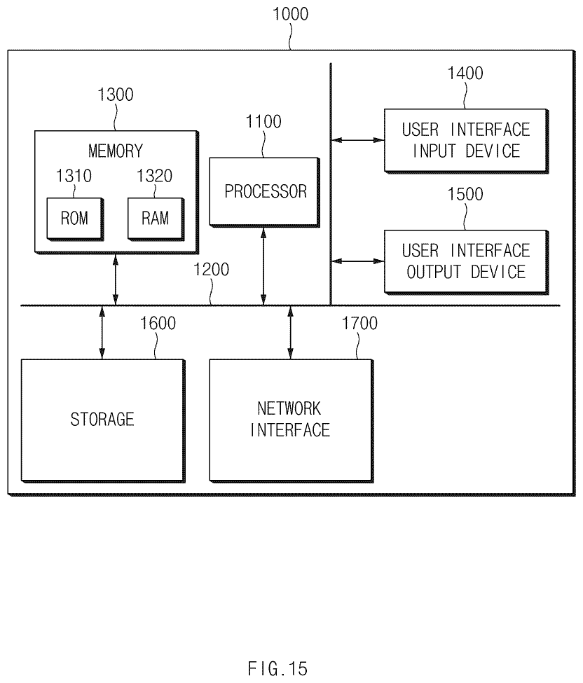

For example, the present disclosure, which relates to an object heading calculation system 1000 (see FIG. 15) using the LiDAR sensor 120 of a vehicle and a deep learning-based AI algorithm, tracks the speed of the host vehicle by using the processor 110 that executes an AI algorithm based on data input from the LiDAR sensor 120 and the memory 130 that stores the input data in conjunction with the processor 110, and generates a first center history for a target object (e.g., another vehicle on a road that is a tracking target, another vehicle driving in front, a merging vehicle, or a nearby moving object, etc.).

Operation S100 may be subdivided into operations S110 and S120, where operation S110 is an operation of tracking the speed of the host vehicle. In this case, the tracking period is made up of a queue of a specified size including the specified number of video frames (e.g., a queue storing 5-10 sequential frames sampled at 10 Hz, etc.).

In operation S120, while the host vehicle is in a stationary state, the center point of the predicted bounding box (i.e., P-Box) for the target object recognized through the LiDAR sensor 120 and deep learning is calculated, and the calculated center point is tracked by the size of the queue mentioned above to generate and store first center history information including a center vector (or a center point vector) (e.g., [x, y, z] displacement vectors over the recent frames, etc.).

For reference, the generation of P-Box by deep learning in the present disclosure is as follows.

For example, autonomous driving is evaluated as the most prominent technology field recently. In addition, in autonomous driving, the bounding box may be understood as a type of annotation applied to a LiDAR sensor image such that an AI machine accurately recognizes and classifies an object (e.g., cars, pedestrians, bicycles, road barriers, etc.).

Bounding box annotation is the process of drawing a rectangle surrounding an object in an image or video such that the machine understands the size, location, orientation, and the like of the object (e.g., defining a 3D box around a vehicle aligned with its driving direction, etc.). The present disclosure proposes a technology capable of correcting heading errors in a bounding box by applying vector technology utilizing a center point to the bounding box output by AI deep learning technology (e.g., adjusting orientation using temporal tracking of center point changes, etc.).

When a bounding box for a vehicle using deep learning AI is generated in operation S100, the sensor points are calculated from the current image frame and the immediately preceding image frame, and the vector connecting the two center points is determined to be the moving direction of the vehicle (e.g., from [x₁, y₁] to [x₂, y₂], forming a motion vector, etc.). The width perpendicular to the moving direction corresponds to the width of the vehicle. For most vehicles, it is safe to assume that the moving direction is the length direction and the direction perpendicular to the moving direction is the width direction (i.e., the breadth) (e.g., for a sedan, the length aligns with the front-rear axis, and the width spans the left-right axis, etc.).

The bounding box based on the LiDAR sensor 120 may be three-dimensional, in which case information about height is also required. Rather than measuring the height individually for each actual vehicle, the average vehicle height of the corresponding vehicle class is often applied (e.g., sedan: 1.45 m, SUV: 1.70 m, etc.). Because the LiDAR sensor 120 is usually installed at a specified height, such as on the vehicle roof or front of the vehicle, the installation height of the LiDAR sensor 120 refers to the distance from the ground to the LiDAR sensor 120 (e.g., approximately 1.6 meters for a typical SUV-mounted roof LiDAR, etc.), and the vehicle height uses the average vehicle height as described above. For reference, because the center point of the bounding box detected in the sensor image is usually located at about half of the actual height, we may also consider inputting only half of the actual vehicle height when inputting the vehicle height (e.g., 0.75 m for a 1.5 m tall vehicle, etc.).

Next, in operation S200, a position history map related to the deep learning P-Box is generated. This will be described in detail by dividing it into operations S210 and S220.

In operation S210, while the host vehicle is in a moving state, the center point according to the movement of the aforementioned target object is tracked, and second center history information including a relative map vector with respect to the currently moving host vehicle is generated and stored (e.g., to capture object motion in a local ego-centric coordinate system, etc.).

Next, in operation S220, a heading vector of a target object is determined by calculating a weighted sum of the center vector and the map vector based on the first weight set for the first center history and the second weight set for the second center history (e.g., assigning w₁=0.6 and w₂=0.4 for balanced heading estimation, etc.). Such a heading vector is the heading information of the object that is precisely calculated according to the present disclosure.

For reference, the above-mentioned center vector vec_{center} may be obtained by following Equation 1.

$$v e {c}_{center} = ( p o {s}_{t} - p o {s}_{t - 1} ) + ( velocity * dt ) \qquad [ Equation 1 ]$$

Where posₜ represents coordinates of the target object in a time t frame belonging to the size of the queue, posₜ₋₁ represents coordinates of the target object in a time t−1 frame belonging to the size of the queue, and velocity represents a driving speed of the host vehicle (e.g., 12 m/s in a straight path, etc.).

In addition, the above-mentioned map vector vecₘₐₚ may be obtained by following Equation 2.

$$v e {c}_{map} = \frac{{\sum }_{t = 0}^{n} p o {s}_{t + 1} - p o {s}_{t}}{n} + ( velocity * dt ) \qquad [ Equation 2 ]$$

Where posₜ₊₁ is coordinates of the target object in a time t+1 frame belonging to the size of the queue, and n is a time corresponding to the size of the queue (e.g., n=5 when using a 5-frame tracking window, etc.).

Finally, the heading vector vec_{heading} according to an example of the present disclosure may be obtained by following Equation 3.

$$v e {c}_{heading} = ( {w}_{1} * v e {c}_{center} ) + ( {w}_{2} * v e {c}_{map} ) \qquad [ Equation 3 ]$$

Where w₁ represents the first weight mentioned above, and w₂ represents the second weight mentioned above.

In particular, in performing operation S220, the first weight is configured to allow the value to increase when the vehicle changes from a stationary state to a moving state, and the second weight is configured to allow the value to increase when the vehicle turns in the moving state (e.g., w₂ becomes dominant during sharp turns or roundabouts, etc.).

Meanwhile, in operation S300, the heading of the target object is extracted to calculate and update the total movement amount of the target object. Specifically, operation S300 may be divided into operations S310 and S320, where, in operation S310, an operation of reconstructing an array of four planar corners of the predicted bounding box is executed based on the heading vector obtained in operation S220 (e.g., aligning the box to face the estimated movement direction such as forward-left or forward-right, etc.). For reference, operation S310 may include an operation of applying a Bayesian filter to four plane corners of the P-Box. In addition, the method may include an operation of applying the Bayesian filter to the heading vector, and may be preferably configured to apply the Bayesian filter to both the P-Box and the heading vector (e.g., to smooth noise in dynamic orientation changes or irregular bounding box jitter, etc.).

In operation S320, an operation of calculating and updating the total movement amount of the distance moved by the target object during the size of the queue is executed based on the size and direction of the heading vector for the target object (e.g., computing displacement magnitude along the heading vector over 10 recent frames, a trajectory of the target object, etc.). In operation S320, additionally, at least one of the first weight or the second weight may be adjusted based on whether the total movement amount is 0 (zero) or greater than a specified value (e.g., if distance <0.1 m, the object may be considered stationary and weights adjusted accordingly, etc.).

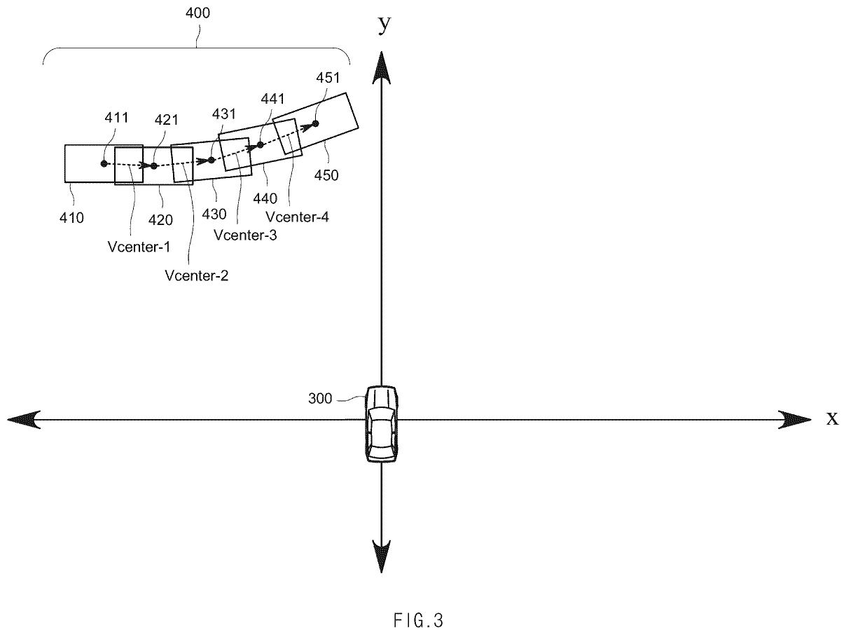

FIG. 3 shows an example of a process of generating first center history information about a center vector by tracking a center point of a P-Box according to an example of the present disclosure (e.g., the vector traces the motion from [x₁, y₁] to [x₂, y₂] over a set of frames, etc.).

In FIG. 3, (x, y) represents a two-dimensional coordinate system. In the present disclosure, not only data processing based on the three-dimensional LiDAR sensor 120, but also heading calculation based on a two-dimensional conversion value of the three-dimensional LiDAR sensor 120 is possible (e.g., projecting 3D points onto the ground plane to simplify horizontal tracking, etc.). Hereinafter, for convenience of explanation, in FIG. 3, it should be noted that the mathematical formulas and algorithms substantially identical to those for the two-dimensional coordinate system may be applied to the three-dimensional coordinate system as well (e.g., same equations applied with additional z-dimension offset or interpolation, etc.).

In FIG. 3, coordinates are shown centered on a host vehicle 300, for example, the LiDAR sensor 120. The host vehicle 300 is located at the (0, 0) point of the coordinate system, and a target object 400 generated by the LiDAR sensor 120 and the deep learning technology described above is shown in the upper left (e.g., representing a sedan, SUV, or motorcycle on the road, etc.). The target object 400 is assumed to be any other vehicle driving on a road.

According to the technique described in FIG. 2, P-Boxes 410, 420, 430, 440, and 450 generated by AI for each time frame for the target object 400 may be generated in time series order (e.g., one P-Box per 100 ms frame when tracking in real-time, etc.). In addition, each P-Box 410, 420, 430, 440, or 450 has a center or center point 411, 421, 431, 441, or 451 calculated according to the technique described in FIG. 2.

According to the present disclosure, the vector connecting the center points 411, 421, 431, 441, and 451 is defined as a “center vector.” Therefore, in FIG. 3, a total of four center vectors may be confirmed, including center vectors Vcenter-1, Vcenter-2, Vcenter-3, and Vcenter-4 (e.g., representing changes in object position over time from rear-left to front-right, etc.). For example, as mentioned above in operation S120 of FIG. 2, center history information including center vectors is generated and stored, and it may be understood that FIG. 3 is a diagram exemplarily explaining operation S120. For reference, the center vector is tracked as much as the size of the queue including a specified number of frames (e.g., queue size=5 frames, or 500 ms of tracking, etc.). For example, the sensor history includes frame data as large as the queue size and the associated individual center vector histories (i.e., Vcenter-1, Vcenter-2, Vcenter-3, and Vcenter-4).

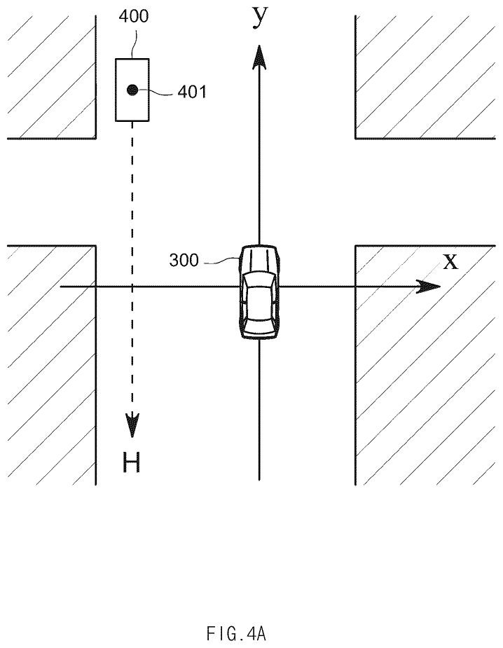

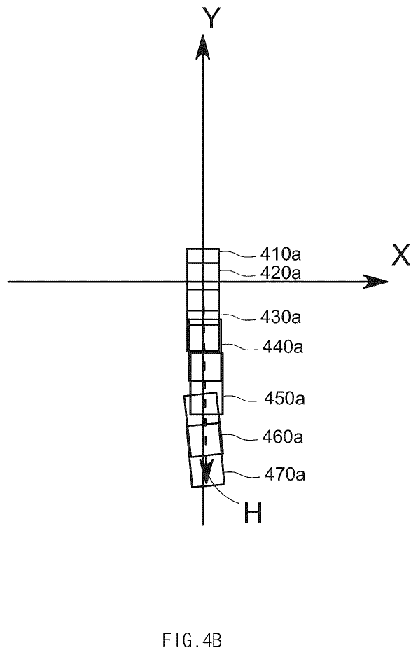

FIG. 4A and FIG. 4B show an example of a process of tracking the center point of a P-Box according to an example of the present disclosure when a vehicle equipped with a LiDAR (i.e., the host vehicle) stops (e.g., waiting at a red light while tracking a moving target vehicle, etc.).

FIGS. 4A and 4B may appear similar to FIG. 3, but there are several differences. For example, the host vehicle 300 stops in FIGS. 4A and 4B, and in FIGS. 4A and 4B, the target object 400 and the center point 401 are tracked by the LiDAR sensor 120 mounted on the stopped host vehicle 300 (e.g., to extract the target's path independent of ego-motion, etc.). Because the P-Box center point (i.e., 401) is also tracked in FIGS. 4A and 4B, it is similar to FIG. 3 in terms of its example, but the purpose of tracking the target object 400 in FIG. 4 is to obtain a so-called map vector regarding the target object 400. However, in FIG. 4, because the host vehicle 300 is stopped, as shown in FIG. 4A, when the target object moves in a direction “H”, as shown in FIG. 4B, the map vector is simply the same as the center vector that tracks the center point 401 of the object 400 (e.g., both vectors point eastward if the object moves rightward, etc.).

In addition, it should be noted that the coordinate system used in FIG. 4B is the local coordinates (X, Y), not the LiDAR coordinates (x, y). For example, the map vector is also generated by tracking the center point 401 of the P-Box 400 generated by deep learning, but the direction of the vector is determined in the local coordinate system (e.g., relative to road lanes or GPS-aligned world axes, etc.).

Referring to FIG. 4B, the tracking results for a total of seven P-Boxes 410a, 420a, 430a, 440a, 450a, 460a, and 470a are shown, and by connecting the center points of a total of seven P-Boxes 410a, 420a, 430a, 440a, 450a, 460a, and 470a in the (X, Y) coordinate system, a map vector in the H direction may be obtained (e.g., averaging displacement vectors over 7 frames to reduce noise, etc.).

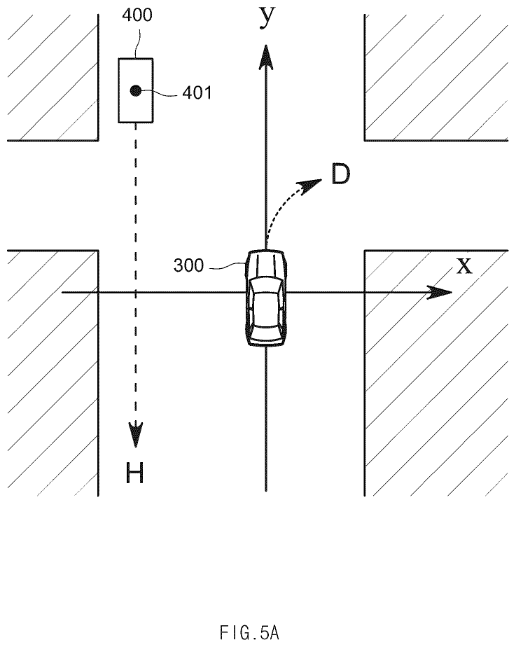

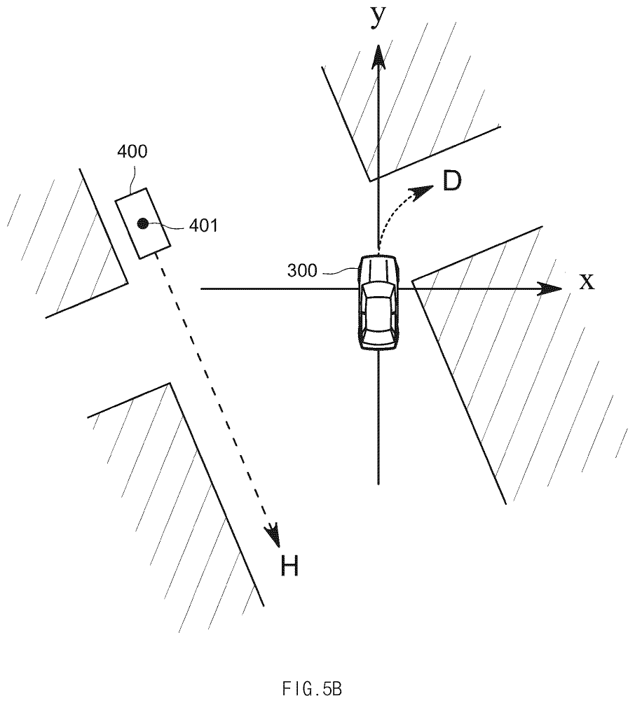

The difference between the center vector and the map vector may be more easily understood in FIGS. 5A and 5B. FIGS. 5A and 5B show an example of a process of generating second center history information regarding a map vector that relatively changes when tracking a center point of a P-Box according to an example of the present disclosure as a vehicle equipped with a LiDAR (i.e., a host vehicle) moves (e.g., merging onto a highway or changing lanes, etc.).

As described above, obtaining a map vector is a key process in operation S210. When, as shown in FIG. 5A, the target object 400 moves in the H direction while the host vehicle 300 makes a right turn in the D direction, the map vector is not located parallel to the y direction perpendicular to the (x, y) coordinate system as shown in FIG. 5B, but may be slanted in the H direction pointing downward to the right with respect to the (x, y) coordinate system due to relativity according to the rotation of the host vehicle 300 (e.g., relative motion effects such as ego-rotation, drift, or yaw deviation of the host vehicle 300).

For example, the map vector may be calculated as in FIGS. 4A to 5B not only when the host vehicle 300 is stopped, but also when the host vehicle 300 moves, and the map vector is an important parameter for obtaining the heading vector according to the present disclosure together with the center vector described above (e.g., to reflect true object direction or trajectory despite host vehicle turns, lane changes, or roundabouts, etc.).

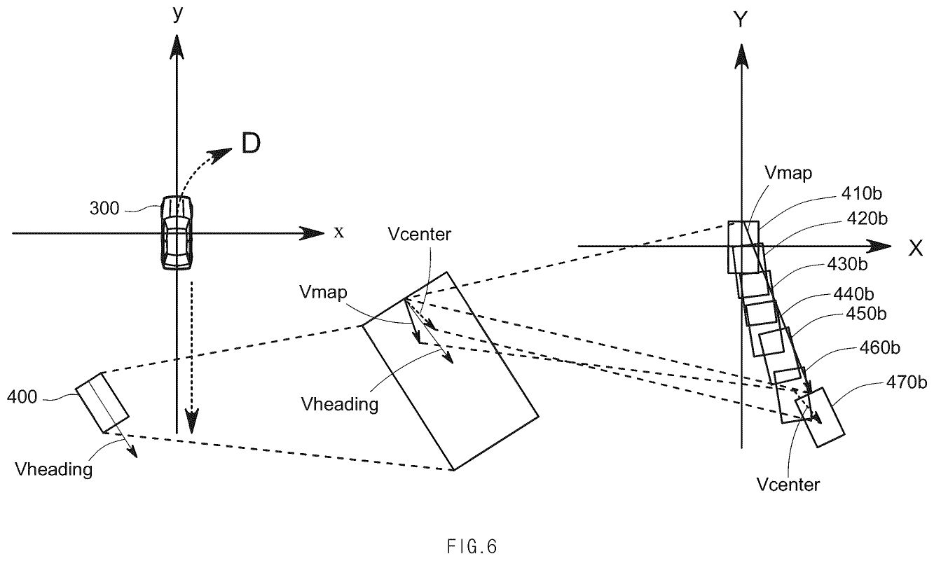

FIG. 6 shows an example of a process of synthesizing a center vector and a map vector according to an example of the present disclosure. For example, FIG. 6 illustrates a process corresponding to operation S220 of FIG. 2, in which a deep learning-based heading vector according to an example of the present disclosure is obtained in operation S220 (e.g., by computing weighted fusion of geometric displacement and relative movement, etc.).

In detail, in FIG. 6, the target object 400 moves on the local coordinate system (X, Y) and leaves traces of a total of 7 P-Boxes 410b, 420b, 430b, 440b, 450b, 460b, and 470b (e.g., representing consecutive positions over 700 ms if each frame is 100 ms apart, etc.). In this case, the center vector is indicated as “Vcenter” in FIG. 6, and is obtained as “Vcenter” in FIG. 6 by tracking the center point of the P-Box within a specified queue range in the same manner as discussed above in FIG. 3.

In FIG. 6, the map vector is generated by connecting the center points of P-Box 410b, 420b, 430b, 440b, 450b, 460b, and 470b in the (X, Y) coordinate system. However, because the host vehicle 300 turns right in the D direction as shown in FIG. 6, the map vector of the target object 400 has the vector direction indicated as “Vmap” in FIG. 6 (e.g., skewed from its original path due to ego-vehicle trajectory curvature, etc.).

Now, according to operation S220, it is time to synthesize Vmap and Vcenter. For the synthesis, in FIG. 6, for convenience, the sizes of Vmap and Vcenter are adjusted at a specified ratio and shown in the center of FIG. 6, and the vector synthesis of Vmap and Vcenter is shown as Vheading in FIG. 6. for example, heading information of the target object 400 obtained based on the deep learning P-Box may reflect a vehicle turning or merging scenario.

The complex operation process described above is simply expressed as only “Vheading”, as shown at the left side of FIG. 6. It may be confirmed that the host vehicle 300 is turning right in the D direction, and Vheading is directed downward to the right based on the LiDAR coordinate system (x, y). This may correspond to real-world maneuvers such as lane changes or curved road tracking.

The scheme for obtaining the center vector is performed according to Equation 1 presented above, the map vector is determined according to Equation 2, and the heading vector is determined according to Equation 3. Each vector may provide complementary data: Vcenter for responsiveness, Vmap for stability, and Vheading for balanced accuracy.

It should be noted that the heading vector is obtained in the form of a weighted sum by applying the first weight to the center vector and the second weight to the map vector in Equation 3, respectively. For example, when exiting a parking lot, the center vector helps identify fast directional change, while the map vector may stabilize cornering behavior. As described above, although the center vector provides a clear indication of the displacement of the current frame compared to the previous frame, the center vector is less robust to erroneous bounding box (P-Box) inference by deep learning. On the other hand, the map vector extracts the displacement on the local coordinate system, so the map vector is more robust, but the map vector has slower response due to its dependency on relative motions (e.g., relativity depending on whether the host vehicle 300 is stopped or moving and the moving speed). Thus, a dynamic weighting scheme may adapt to motion state transitions, e.g., from idle to acceleration or cruising to braking. Specifically, the examples of the present disclosure evaluate that the center vector has a fast response to the target object 400 when the host vehicle 300 is in a state of starting from a signal standby, and that the map vector is stable and robust when the target object 400 moves or turns (if the target object and the host vehicle do not move, the map vector is 0 (zero)). Therefore, the map vector may give greater meaning to the vector value in heading calculation if the target object moves.

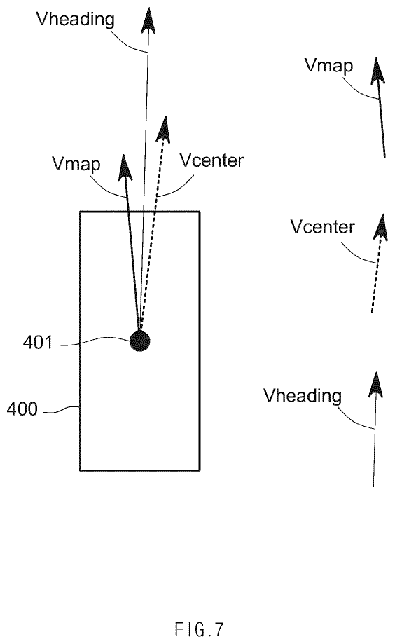

FIG. 7 show an example of the relationship between each vector according to Equation 1 to Equation 3 applied according to an example of the present disclosure.

In FIG. 7, “Vcenter” is vec_{center} determined according to Equation 1, “Vmap” is vecₘₐₚ determined according to Equation 2, and “Vheading” is vec_{heading} determined according to Equation 3. It should be noted that the vectors are calculated based on the P-Box of the target object 400 and its center point 401 generated by deep learning, as shown in FIG. 7. Each vector originates from the center point of a P-Box detected by a sensor (e.g., LiDAR) and deep learning inference pipeline.

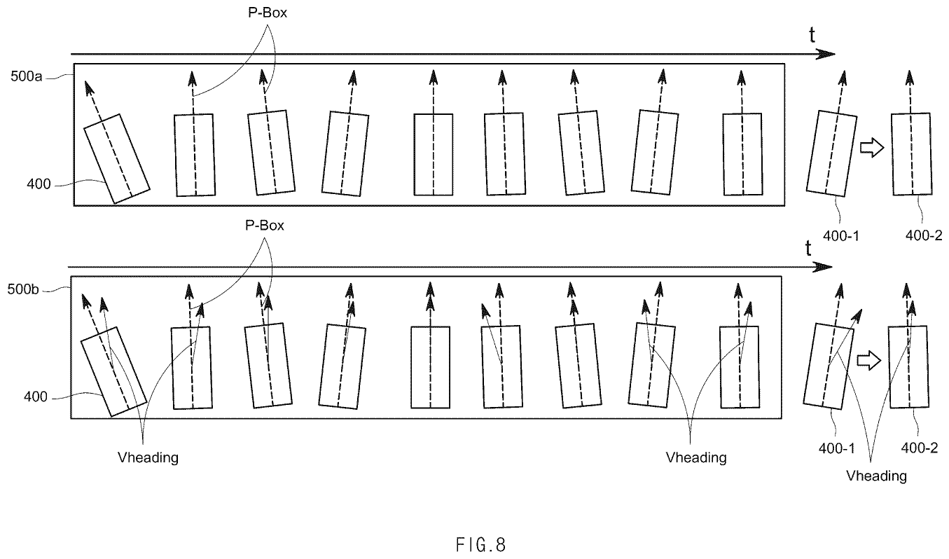

As described above in FIG. 2, operation S310 is an operation in which heading stabilization filtering is performed. In this regard, FIG. 8 shows an example of a process of applying a Bayesian filter to a center vector and a map vector according to an example of the present disclosure. These filters may refine noisy bounding box detections and avoid overreacting to jitter in real-time sensor input.

Bayesian filters 500a and 500b are tools to enable stable P-Box tracking by correcting incorrect P-Box inference of a deep learning network. For example, the Bayesian filter 500a smooths abrupt P-Box corner jumps, while the Bayesian filter 500b adjusts heading based on historical direction trends. This correction helps avoid “flip” errors where the object's front and rear are reversed. As shown in FIG. 8, the present disclosure proposes a scheme of applying the Bayesian filter 500a for P-Box point (i.e., in the case of a two-dimensional square, there are four corner points, but the four corners of the target object 400 are not aligned to the actual direction of the vehicle, and sometimes the target object 400 may be misrecognized as if the target object 400 faces a reversed direction. When monitoring over queues of frames, the past heading vector history may be smoothed via Bayesian filtering to yield stable predictions. The present disclosure calls this history contamination) and applying the Bayesian filter 500b for the heading vector Vheading. For example, when continuous monitoring is performed in queue units, the past heading vector history may be known as in FIG. 8, and the present disclosure may implement a smooth moving image of the target object 400 when tracking the target object 400 by applying a Bayesian filter to these heading vector values. For reference, as clearly shown in FIG. 8, the P-Box point and the heading vectors may influence each other, but that does not mean they are interdependent or dependent. For example, P-Box filtering and heading vector smoothing may operate in parallel. For example, the filters work independently, allowing one to adapt faster without destabilizing the other.

For reference, the Bayesian filter 500a may reduce the P-Box shaking phenomenon caused by filtering the P-Box point (e.g., inconsistent corner estimation). The Bayesian filter 500b enables stable determination of the speed of the target object 400, whether moving/stationary, and the movement direction of the target object 400 based on the heading vector. For example, the Bayesian filter 500a may differentiate whether an object is reversing or stopped at an intersection.

In FIG. 8, it may be confirmed that the P-Box and heading vector of the target object are corrected from reference numeral 400-1 to reference numeral 400-2 by the Bayesian filters 500a and 500b, respectively. This may lead to more reliable trajectory tracking for downstream tasks like collision prediction or path planning.

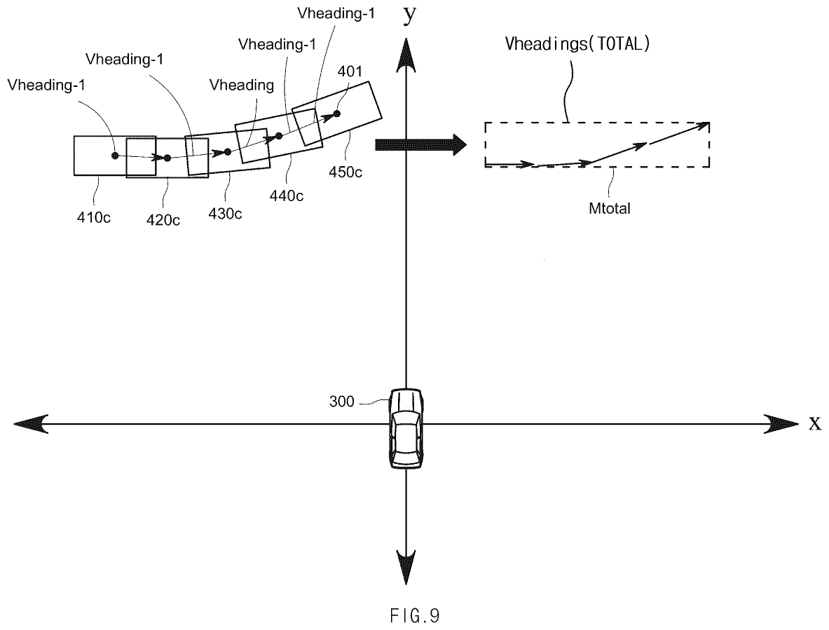

FIG. 9 shows an example of a process of calculating the total movement amount of a target object according to an example of the present disclosure. For example, FIG. 9 is a drawing specifically explaining operation S320 described in FIG. 2 above. The movement amount may reflect cumulative path changes rather than just instantaneous displacement.

Referring to FIG. 9, it is possible to confirm that a total of five P-Boxes 410c, 420c, 430c, 440c, and 450c move based on the host vehicle 300. In addition, a total of four Vheading vectors Vheading-1, Vheading-2, Vheading-3, and Vheading-4 are shown together according to the method described in Equation 3 and FIGS. 6 and 7 above. These vectors represent directional shifts across frame intervals, offering insights into object trajectory smoothness or erratic behavior.

The present disclosure proposes to obtain a total movement amount Mtotal of the target object 400 as Vheadings, for example, the sum of the heading vectors, by using the heading vectors produced according to the present disclosure. Unlike Euclidean distance, this reflects both magnitude and direction of accumulated movement over the frame queue. As shown in FIG. 9, the total movement amount according to the present disclosure is a different concept from the Euclidean distance, which is the shortest distance, and is an indicator for estimating how much an object has moved in the current frame in the size and direction of the heading vector.

In addition, the total movement amount of the target object 400 may be applied as follows. For example, because the target object vehicle waiting for a signal has no movement (e.g., stationary at a red light), it may be difficult to extract the heading vector. For example, in a situation where Mtotal is 0 (zero), it is possible to substitute past heading vectors based on analysis of the queue including the frames up to just before stopping, rather than calculating real-time heading vectors. This may prevent false heading updates when the object is briefly motionless. When the target object vehicle is moving enough to calculate the heading vector, the heading of the object may be determined by the heading vector calculated in real time. This allows flexible switching between predictive and reactive modes in dynamic urban environments.

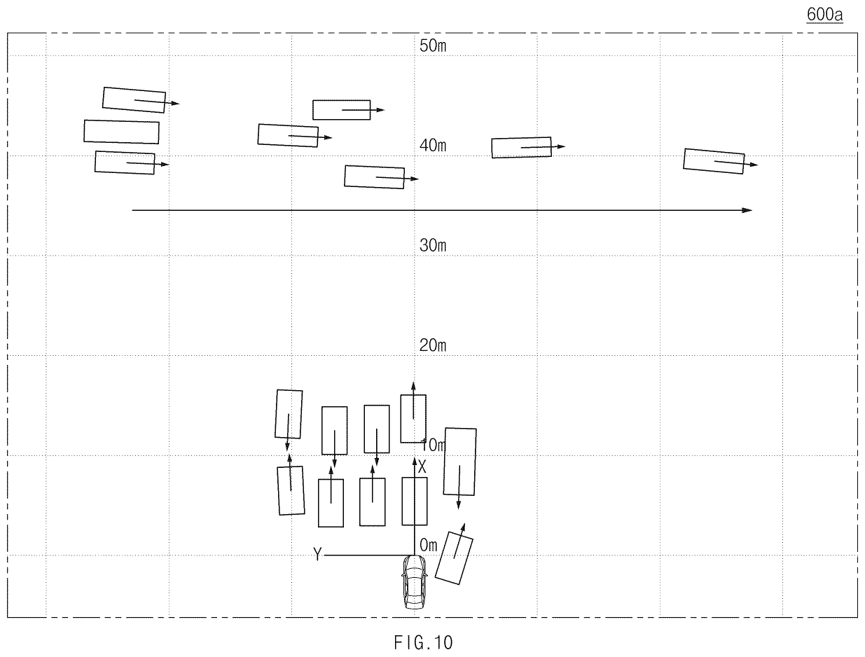

FIG. 10 shows a first example 600a to which an example of the present disclosure is applied. As shown in FIG. 10, when the present disclosure is applied, it is possible to maintain a stable heading (arrow in the data screen of FIG. 10) and P-Box (red square) in an intersection situation. For example, even when multiple vehicles converge from different directions, the heading remains steady without sudden jumps caused by temporary occlusions.

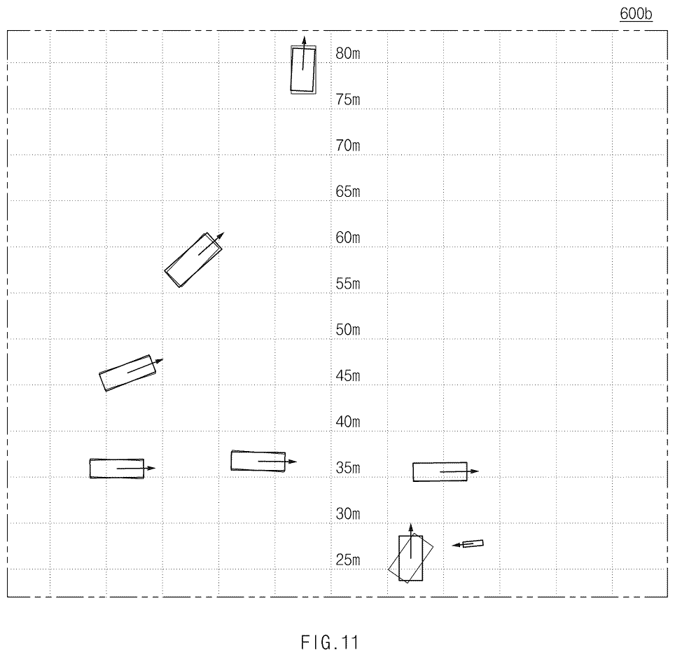

FIG. 11 shows a second example 600b to which an example of the present disclosure is applied. As shown in FIG. 11, it may be confirmed that stable heading and P-Box maintenance are possible even for a target object moving laterally or diagonally in an intersection situation. In particular, it may be confirmed that the GT bounding box (yellow) and the P-Box (red) overlap almost identically. For example, a cyclist crossing diagonally through an intersection maintains alignment between the inferred and ground truth boxes without drift.

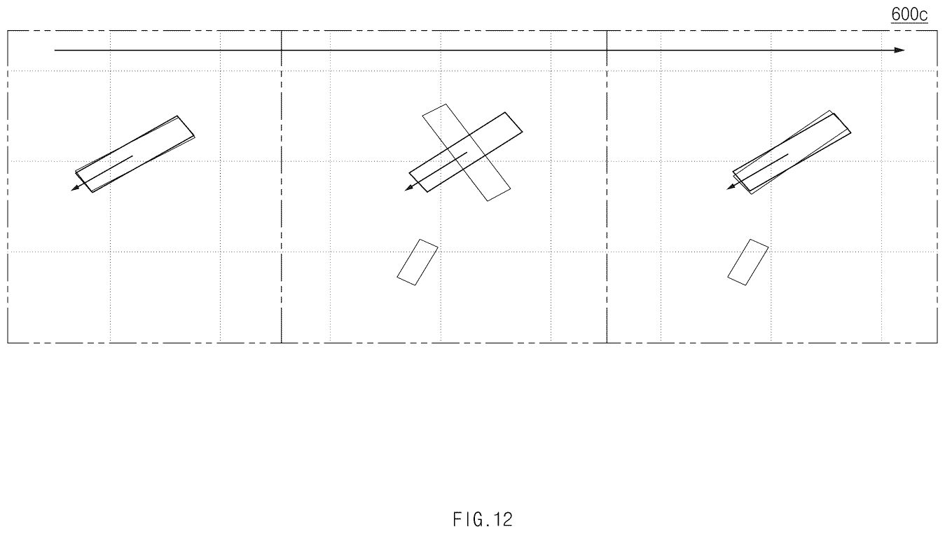

FIG. 12 shows a third example 600c to which an example of the present disclosure is applied. For example, in FIG. 12, it may be confirmed that stable heading and P-Box tracking results are still output even if the P-Box inference according to deep learning is incorrect. For example, when a small delivery truck is misclassified as a sedan, the heading vector remains accurate based on historical center vectors and filtered motion paths.

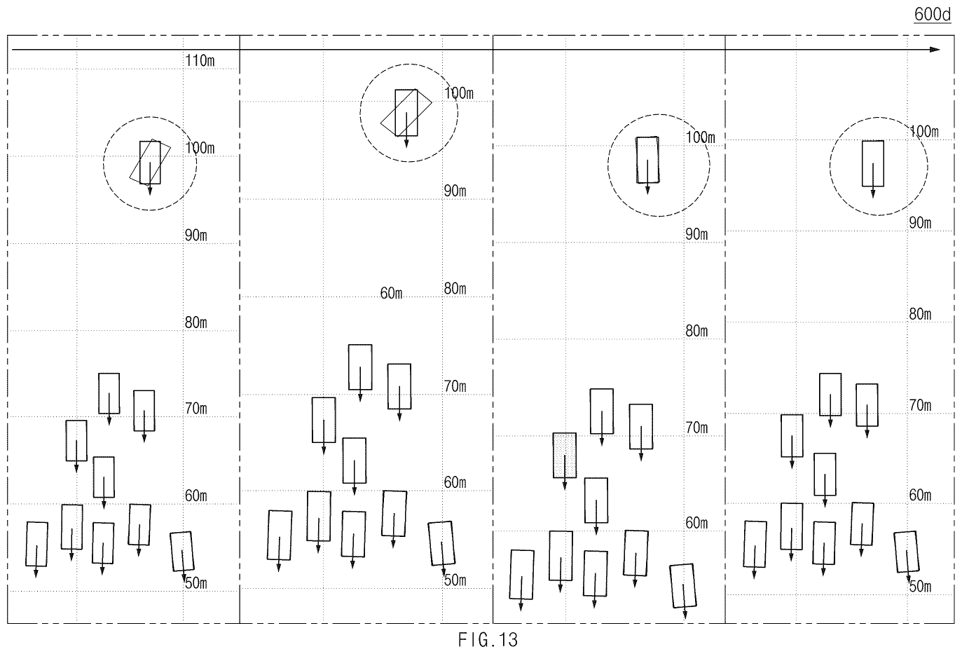

FIG. 13 shows a fourth example 600d to which an example of the present disclosure is applied. For example, in FIG. 13, as in FIG. 12, it may be confirmed that stable heading and P-Box tracking results are still output even if the P-Box inference based on deep learning is incorrect. For example, when a bus is partially occluded and incorrectly inferred as two separate objects, the system still outputs a unified heading vector based on consistent tracking across frames.

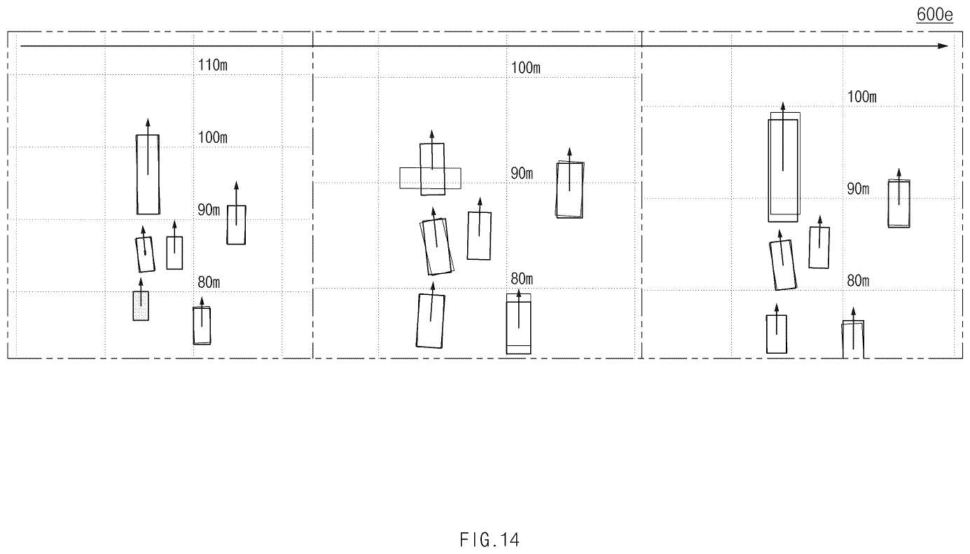

FIG. 14 shows a fifth example 600e to which an example of the present disclosure is applied. For example, it may be understood that when deep learning inference is incorrect, such as when there is heading inversion or class classification error, it is possible to correct it by applying the present disclosure. For instance, if a parked motorcycle is mistakenly classified as a moving bicycle with reversed heading, the system corrects the error using past heading vectors and Bayesian filtering.

FIG. 15 shows an example of a computing system 1000 for autonomous vehicle control and object recognition operations according to an example of the present disclosure. The computing system 1000 of FIG. 15 may correspond to the system 1000 equipped with the algorithm 200 for calculating object heading using the LiDAR sensor 120 of a vehicle and the deep learning-based AI algorithm according to an example of the present disclosure, or may be configured to include the same. In addition, the system 1000 according to an example of the present disclosure may be mounted as a stand-alone device in a vehicle, and it is also possible to configure the system to implement the algorithm 200 according to an example of the present disclosure through wireless communication between a cloud server (not shown) and the vehicle (i.e., a client). For example, the algorithm may run locally on an onboard processor or remotely on a server with updates sent to the vehicle in real-time via V2X communication.

Referring to FIG. 15, the computing system 1000 may include at least one processor 1100, a memory 1300, a user interface input device 1400, a user interface output device 1500, storage 1600, and a network interface 1700 connected through a bus 1200. For example, the input device may include a touchscreen or microphone, while the output device may be a display or speaker in the vehicle dashboard.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) and a random access memory (RAM). For example, the memory 1300 may include ROM for storing boot instructions and RAM for temporarily caching LiDAR data during real-time object detection.

Accordingly, the processes of the method or algorithm described in relation to the examples of the present disclosure may be implemented directly by hardware executed by the processor 1100, a software module, or a combination thereof. The software module may reside in a storage medium (e.g., the memory 1300 and/or the storage 1600), such as a RAM memory, a flash memory, a ROM memory, an EPROM memory, an EEPROM memory, a register, a hard disk, solid state drive (SSD), a detachable disk, or a CD-ROM. For example, a software module for heading vector computation may be stored in RAM and executed by the processor during each LiDAR frame cycle.

The exemplary storage medium is coupled to the processor 1100, and the processor 1100 may read information from the storage medium and may write information in the storage medium. For example, the processor may read a neural network model from SSD storage and write updated inference results into RAM during LiDAR point processing. In another method, the storage medium may be integrated with the processor 1100. The processor and the storage medium may reside in an application specific integrated circuit (ASIC). For example, an ASIC designed for object detection may contain both memory for model weights and a processor for real-time heading vector computation. The ASIC may reside in a user terminal. For example, the user terminal may be a vehicle-mounted computing module that performs real-time LiDAR data processing on board. In another method, the processor and the storage medium may reside in the user terminal as an individual component.

According to one example of the present disclosure, a system for calculating an object heading by using a LiDAR sensor of a vehicle and a deep learning-based artificial intelligence (AI) algorithm includes a processor that executes the AI algorithm based on data input from the LiDAR sensor, and a memory that stores the input data in conjunction with the processor. The AI algorithm executes generating and storing driving history information by storing data on a driving speed of the vehicle in a queue of a specified size, calculating a center point of a predicted bounding box for a target object recognized by the LiDAR sensor and the deep learning while the vehicle is in a stationary state, and generating and storing first center history information including a center vector by tracking the calculated center point based on the size of the queue, generating and storing second center history information including a relative map vector with respect to the vehicle by tracking the center point according to a movement of the target object while the vehicle is in a moving state, and determining a heading vector of the target object by obtaining a weighted sum of the center vector and the map vector included in the first center history and the second center history based on a first weight for the first center history and a second weight for the second center history.

According to an example, the center vector may be obtained as follows:

$$v e {c}_{center} = ( p o {s}_{t} - p o {s}_{t - 1} ) + ( velocity * dt )$$

Where vec_{center} represents the center vector, posₜ represents coordinates of the target object in a time t frame belonging to the size of the queue, posₜ₋₁ represents coordinates of the target object in a time t−1 frame belonging to the size of the queue, and velocity represents the driving speed of the vehicle.

According to an example, the map vector may be obtained as follows:

$$v e {c}_{m a p} = \frac{{\sum }_{t = 0}^{n} p o {s}_{t + 1} - p o {s}_{t}}{n} + ( velocity * dt )$$

Where vecₘₐₚ represents the map vector, posₜ₊₁ is coordinates of the target object in a time t+1 frame belonging to the size of the queue, and n is a time corresponding to the size of the queue.

According to an example, the heading vector of the target object may be obtained as follows:

$$v e {c}_{heading} = ( {w}_{1} * v e {c}_{center} ) + ( {w}_{2} * v e {c}_{map} )$$

Where vec_{heading} represents the heading vector, w₁ represents the first weight, and w₂ represents the second weight.

According to an example, the first weight may increase in value when the vehicle changes from the stationary state to the moving state, and the second weight may increase in value when the vehicle turns while moving.

According to an example, the AI algorithm may further execute reconstructing an array of four plane corners of the predicted bounding box based on the heading vector.

According to an example, the reconstructing of the array of four plane corners may include applying a Bayesian filter to the four plane corners.

According to an example, the reconstructing of the array of four plane corners may include applying a Bayesian filter to the heading vector.

According to an example, the AI algorithm may further execute calculating and updating a total movement amount of a distance moved by the target object in the queue based on a magnitude and a direction of the heading vector.

According to an example, the AI algorithm may further execute adjusting at least one of the first weight or the second weight based on whether the total movement amount is equal to 0 (zero) or greater than a specified value.

According to another example of the present disclosure, a method of calculating an object heading by using a LiDAR sensor of a vehicle and a deep learning-based artificial intelligence (AI) algorithm includes generating and storing driving history information by storing data on a driving speed of the vehicle in a queue of a specified size, calculating a center point of a predicted bounding box for a target object recognized by the LiDAR sensor and the deep learning while the vehicle is in a stationary state, and generating and storing first center history information including a center vector by tracking the calculated center point based on the size of the queue, generating and storing second center history information including a relative map vector with respect to the vehicle by tracking the center point according to a movement of the target object while the vehicle is in a moving state, and determining a heading vector of the target object by obtaining a weighted sum of the center vector and the map vector included in the first center history and the second center history based on a first weight for the first center history and a second weight for the second center history.

The present disclosure adopts deep learning technology to overcome the limitations of existing LiDAR-based heading analysis. Furthermore, the P-Box generated by AI in the center data input from the LiDAR is tracked in units of queues including a specified number of frames, the relative tracking information of the P-Box center point is obtained depending on whether the vehicle on which the LiDAR is installed (i.e., the host vehicle) is driving or stopped, and based on the relative tracking information, two vector components, a center vector and a map vector, are obtained.

According to the present disclosure, the center vector and the clear displacement of the current frame compared to the previous frame may be known, but the robustness is weak if the AI inference is incorrect, and the map vector extracts the displacement in the local coordinate system of the LiDAR, so it is analyzed that the robustness is excellent, but the responsiveness is slow.

Based on such analysis, the present disclosure proposes a new technique for calculating a heading vector by comprehensively incorporating only the advantages of a center vector being fast in response to an object starting from a signal waiting state and a map vector being stable and robust if a target object moves or turns.

Therefore, according to the heading calculation system and method of the present disclosure, compared to the related art, it is possible to improve the accuracy of object heading determination and correct the phenomenon of P-Box inversion. In particular, even if the P-Box operation based on deep learning is incorrect, it is possible to reliably track the target object (e.g., another vehicle on the road).

In addition, through the detailed description of the present disclosure and the attached drawings, those skilled in the art will be able to understand various effects other than the effects described above from the present disclosure.

Although examples of the present disclosure have been described for exemplary purposes, those skilled in the art will appreciate that various modifications, additions, and substitutions are possible, without departing from the scope and spirit of the disclosure.

Therefore, disclosed in the present disclosure are provided for the sake of descriptions, not limiting the technical concepts of the present disclosure, and it should be understood that such examples are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus of a vehicle, the apparatus comprising:
a processor; and
a memory storing at least one instruction that, when executed by the processor communicating with the memory, is configured to cause the apparatus to:
generate and store, based on data about a driving speed of the vehicle, driving history information, wherein the data is stored in a queue of a specified size in the memory,
determine a center point of a predicted bounding box for a target object recognized by a sensor of the vehicle and a deep learning model while the vehicle is in a stationary state,
generate and store first center history information comprising a center vector, wherein the first center history information is generated and stored based on tracking the determined center point and the specified size of the queue,
generate and store second center history information comprising a relative map vector with respect to the vehicle, wherein the second center history information is generated and stored based on tracking the determined center point and a movement of the target object while the vehicle is in a moving state,
based on a first weight for the first center history information and a second weight for the second center history information, determine a heading vector of the target object by obtaining a weighted sum of the center vector and the relative map vector,
output a signal indicating the heading vector of the target object, and
control, based on the signal, autonomous driving of the vehicle.

2. The apparatus of claim 1, wherein the center vector is defined as follows:
$$v e {c}_{center} = ( p o {s}_{t} - p o {s}_{t - 1} ) + ( velocity * dt )$$
wherein vec_{center} represents the center vector, posₜ represents coordinates of the target object in a time t frame belonging to the specified size of the queue, posₜ₋₁ represents coordinates of the target object in a time t−1 frame belonging to the specified size of the queue, and velocity represents the driving speed of the vehicle.

3. The apparatus of claim 2, wherein the relative map vector is defined as follows:
$$v e {c}_{map} = \frac{{\sum }_{t = 0}^{n} p o {s}_{t + 1} - p o {s}_{t}}{n} + ( velocity * dt )$$
wherein vecₘₐₚ represents the relative map vector, posₜ₊₁ is coordinates of the target object in a time t+1 frame belonging to the specified size of the queue, and n is a time corresponding to the specified size of the queue.

4. The apparatus of claim 3, Wherein the heading vector of the target object is defined as follows:
$$v e {c}_{heading} = ( {w}_{1} * v e {c}_{center} ) + ( {w}_{2} * v e {c}_{map} )$$
wherein vec_{heading} represents the heading vector, w₁ represents the first weight, and w₂ represents the second weight.

5. The apparatus of claim 1, wherein the first weight increases in value when the vehicle changes from the stationary state to the moving state, and the second weight increases in value when the vehicle turns while in the moving state.

6. The apparatus of claim 1, wherein the at least one instruction, when executed by the processor communicating with the memory, is configured to cause the apparatus to execute reconstructing, based on the heading vector, an array of four plane corners of the predicted bounding box.

7. The apparatus of claim 6, wherein the reconstructing of the array of four plane corners comprises applying a Bayesian filter to the four plane corners.

8. The apparatus of claim 6, wherein the reconstructing of the array of four plane corners comprises applying a Bayesian filter to the heading vector.

9. The apparatus of claim 1, wherein the at least one instruction, when executed by the processor communicating with the memory, is configured to cause the apparatus to execute calculating and updating, based on a magnitude and a direction of the heading vector, a total movement amount of a distance moved by the target object in the queue.

10. The apparatus of claim 9, wherein the at least one instruction, when executed by the processor communicating with the memory, is configured to cause the apparatus to execute adjusting, based on whether the total movement amount being equal to zero or greater than a specified value, at least one of the first weight or the second weight.

11. A method performed by an apparatus of a vehicle, the method comprising:
generating and storing, based on data about a driving speed of the vehicle, driving history information, wherein the data is stored in a queue of a specified size in a memory of the vehicle;
determining a center point of a predicted bounding box for a target object recognized by a sensor of the vehicle and a deep learning model while the vehicle is in a stationary state,
generating and storing first center history information comprising a center vector, wherein the first center history information is generated and stored based on tracking the determined center point and the specified size of the queue;
generating and storing second center history information comprising a relative map vector with respect to the vehicle, wherein the second center history information is generated and stored based on tracking the determined center point and a movement of the target object while the vehicle is in a moving state;
based on a first weight for the first center history information and a second weight for the second center history information, determining a heading vector of the target object by obtaining a weighted sum of the center vector and the relative map vector;
outputting a signal indicating the heading vector of the target object; and
controlling, based on the signal, autonomous driving of the vehicle.

12. The method of claim 11, wherein the center vector is defined as follows:
$$v e {c}_{center} = ( p o {s}_{t} - p o {s}_{t - 1} ) + ( velocity * dt )$$
wherein vec_{center} represents the center vector, posₜ represents coordinates of the target object in a time t frame belonging to the specified size of the queue, posₜ₋₁ represents coordinates of the target object in a time t−1 frame belonging to the specified size of the queue, and velocity represents the driving speed of the vehicle.

13. The method of claim 12, wherein the relative map vector is defined as follows:
$$v e {c}_{map} = \frac{{\sum }_{t = 0}^{n} {pos}_{t + 1} - p o {s}_{t}}{n} + ( velocity * dt )$$
wherein vecₘₐₚ represents the relative map vector, posₜ₊₁ is coordinates of the target object in a time t+1 frame belonging to the specified size of the queue, and n is a time corresponding to the specified size of the queue.

14. The method of claim 13, wherein the heading vector of the target object is defined as follows:
$$v e {c}_{heading} = ( {w}_{1} * v e {c}_{center} ) + ( {w}_{2} * v e {c}_{map} )$$
wherein vec_{heading} represents the heading vector, w₁ represents the first weight, and w₂ represents the second weight.

15. The method of claim 11, wherein the first weight increases in value when the vehicle changes from the stationary state to the moving state, and the second weight increases in value when the vehicle turns while in the moving state.

16. The method of claim 11, further comprising:
Reconstructing, based on the heading vector, an array of four plane corners of the predicted bounding box.

17. The method of claim 16, wherein the reconstructing of the array of four plane corners comprises applying a Bayesian filter to the four plane corners.

18. An apparatus of a vehicle, the apparatus comprising:
a processor; and
a memory storing at least one instruction that, when executed by the processor communicating with the memory, is configured to cause the apparatus to:
store a driving speed history of the vehicle and a center point history of a predicted bounding box associated with a target object, wherein the predicted bounding box is generated based on sensor data obtained from a sensor of the vehicle and a deep learning model,
generate, based on tracking the center point history of the predicted bounding box while the vehicle is in a stationary state, a first center history comprising a center vector,
generate, based on tracking the center point history of the predicted bounding box while the vehicle is in a moving state, a second center history comprising a map vector,
determine a heading vector of the target object based on the center vector and the map vector,
apply a filter to the heading vector,
determine, based on a magnitude and a direction of the filtered heading vector, a total movement amount of the target object, and
output, based on the filtered heading vector and the total movement amount of the target object, a signal indicating a heading of the target object and a trajectory of the target object.

19. The apparatus of claim 18, wherein the at least one instruction, when executed by the processor communicating with the memory, is configured to cause the apparatus to determine the heading vector of the target object by:
determining a displacement between center point coordinates of the predicted bounding box in a current frame and a previous frame to obtain the center vector; and
determining a relative displacement of predicted bounding box with respect to a reference frame to obtain the map vector, wherein the reference frame corresponds to a frame whose origin and orientation are defined relative to the vehicle and remain constant with respect to the vehicle.

20. The apparatus of claim 18, wherein the at least one instruction, when executed by the processor communicating with the memory, is configured to cause the apparatus to apply corrections for inconsistencies in an arrangement of corner points of the predicted bounding box, and
wherein the at least one instruction, when executed by the processor communicating with the memory, is configured to cause the apparatus to:
determine the heading vector by determining, based on a weighted sum of the center vector and the map vector, the heading vector, wherein a first weight is applied to the center vector and a second weight is applied to the map vector, and wherein at least one of the first weight and second weight is adjusted based on a movement state of the vehicle or a movement state of the target object, and
apply the filter to the heading vector to reduce variations in heading estimation of the predicted bounding box.
